(19) United States
(12) Patent Application Publication
(10) Pub. No.: US 2024/0363270 A1
(43) Pub. Date: Oct. 31, 2024

(54) METHOD OF PREPARING MAGNETIC POWDER AND MAGNETIC POWDER

(71) Applicants: HYUNDAI MOTOR COMPANY, Seoul (KR); KIA CORPORATION, Seoul (KR); INDUSTRY-UNIVERSITY COOPERATION FOUNDATION HANYANG UNIVERSITY ERICA CAMPUS, Ansan-si (KR)

(72) Inventors: Bo Kyeong Han, Hwaseong-si (KR); Sae Mee Yun, Hwaseong-si (KR); Kang Mo Koo, Ansan-si (KR); Yong Ho Choa, Ansan-si (KR); Byung Kwon Jang, Pyeongtaek-si (KR)

(73) Assignees: HYUNDAI MOTOR COMPANY, Seoul (KR); KIA CORPORATION, Seoul (KR); INDUSTRY-UNIVERSITY COOPERATION FOUNDATION HANYANG UNIVERSITY ERICA CAMPUS, Ansan-si (KR)

(21) Appl. No.: 18/376,273

(22) Filed: Oct. 3, 2023

(30) Foreign Application Priority Data
Apr. 27, 2023 (KR) 10-2023-0055773

(51) Int. Cl. H01F 1/057; B22F 1/05; B22F 3/02; B22F 9/04; B22F 9/22; C22C 33/02; C22C 38/00; H01F 41/02

(52) U.S. Cl. CPC H01F 1/0571; B22F 1/05; B22F 3/02; B22F 9/04; B22F 9/22; C22C 33/0235; C22C 38/005; H01F 41/0253; B22F 2201/013; B22F 2201/10; B22F 2301/355; B22F 2304/05; B22F 2998/10; C22C 2202/02

(57) ABSTRACT

A method of preparing a magnet powder, and a magnet powder, are disclosed. The method includes: preparing a neodymium praseodymium (Nd, Pr) mixed oxide containing Nd and Pr; preparing iron (Fe) oxide; preparing boron (B) oxide; mixing the prepared (Nd, Pr) mixed oxide, iron oxide, and boron oxide to prepare a first mixture; mixing the first mixture with calcium (Ca) to prepare a second mixture; inducing diffusion while shaping and pressing the second mixture; reducing the shaped and pressed second mixture to prepare a magnetic substance containing Nd, Fe, and B; powdering the reduced magnetic substance; and removing reduction by-products from the powdered magnetic substance.

### CROSS-REFERENCE TO RELATED APPLICATION

The present application claims priority to Korean Patent Application No. 10-2023-0055773 filed on Apr. 27, 2023, the entire contents of which are incorporated herein for all purposes by this reference.

### BACKGROUND

### Field of the Disclosure

The present disclosure relates to a method of preparing a magnetic powder and the magnetic powder. More particularly, the present disclosure relates to a method of preparing a magnetic powder and the magnetic powder in which a magnetic powder with a small average size can be obtained by utilizing a neodymium praseodymium (Nd, Pr) mixed oxide extracted from a waste permanent magnet.

### Description of the Related Art

Magnetic materials are materials used to convert electrical and mechanical energy into each other, and core materials that are widely used in high-efficiency motors and generators.

These magnetic materials are divided into soft magnetic and hard magnetic materials according to the magnitude of an external magnetic field that can change a direction of a magnetic pole. Hard magnetic materials, i.e., permanent magnets always generate a magnetic field since magnetic poles are generally aligned in a certain direction through magnetization, which can be used to generate torque without additional energy supply.

Performance of the permanent magnet can be expressed as a B×H value, which is the product of an external magnetic field H applied to a magnet and a magnetic field B provided by the magnet at an operating point. A maximum value is defined as a maximum magnetic energy product (BH) max, which is represented by a performance index of the permanent magnet.

In recent years, the magnetic materials in the transportation and energy industries have been utilized in main power conversion devices instead of auxiliary positions. Also, the demand for high-performance permanent magnets in next-generation industries is increasing.

In particular, the demand for electric vehicles has been increasing rapidly in recent years due to the substitution of petroleum energy and the increasing importance of low-carbon green growth. For this reason, the demand for permanent magnet magnetic materials continues to increase as motors used in the electric vehicles become more efficient, lighter, and smaller.

At present, ferrite and Nd-based magnets are the most widely used as the magnetic materials. Nd-based magnets require only about ⅛ of the volume compared to ferrite magnets to obtain the same level of energy. Therefore, the ferrite-based magnets are used for low-cost and low-performance products, while the Nd-based magnets with high maximum magnetic energy product are used for high-efficiency and high-performance products.

In recent years, the demand for high-efficiency permanent magnet motors has been increasing rapidly in the hybrid and electric vehicle industry to meet the requirements of miniaturization, weight reduction, and increased efficiency of products, in response to the movement to achieve carbon neutrality. Also, NdFeB-based magnets, a compound of neodymium (Nd), which is a rare earth element with the highest magnetic properties of the existing magnets, iron (Fe), and boron (B), are being used primarily in the hybrid and electric vehicle industry.

A core material in the NdFeB-based magnet is neodymium (Nd), a rare earth element. However, neodymium (Nd) has small reserves, most of which are stored in China. With the Chinese government implementing restrictions on the export of rare earth materials and conflicts arising over the securing of rare earth resources, there is a high risk associated with rare earth materials.

However, it is anticipated that the demand for NdFeB-based magnets will continue to increase due to the growing emphasis on environmental sustainability. With the substantial rise in demand for electric vehicles, it is anticipated that a large quantity of NdFeb based magnets will be discarded because of the related component aging in the near future.

Therefore, research on the technology to recycle waste permanent magnets extracted from the waste drive motors of electric vehicles to reproduce magnetic materials is expected to be actively conducted for the purpose of securing rare earth resources, utilizing waste permanent magnets, and responding to the eco-friendly energy market.

Meanwhile, strip/mold casting or melt spinning methods based on metal powder metallurgy are generally known for preparing NdFeB-based magnets.

First, for the strip/mold casting method, metals such as neodymium (Nd), iron (Fe), and boron (B) are melted through heating to produce ingots, which are then crushed into crystalline particles. Micro-sized particles are produced through a fine particle refinement process. Repeating this process, the powder is obtained, pressed, and sintered under a magnetic field to produce anisotropic sintered magnets.

In addition, the melt spinning method involves melting the metal elements and pouring the melted material onto a rapidly rotating wheel for rapid cooling. Afterward, the material is jet milled for pulverization and then blended with polymers to form bonded magnets or pressed to manufacture magnets.

However, there are problems in that these methods require a crushing process, which is time-consuming, and require a process for surface coating of the powder after crushing. In addition, since the existing Nd2Fe14B micro-particles are prepared by multistage treatment of coarse grinding and hydrogen crushing/jet milling of the lump obtained by melting (1500-2000° C.) and quenching the raw material, the particle shape is irregular and there are limitations in particle refinement.

Therefore, a method for preparing magnetic powders by calcium reduction-diffusion has recently been gaining attention. For example, uniform NdFeb micro-particles may be prepared by a reduction-diffusion process in which neodymium oxide (Nd₂O₃), Fe, and B are mixed and reduced with calcium (Ca), etc. However, there is a problem in that these methods utilize micro-iron powder (mainly carbonyl iron powder) as a starting material. This makes it impossible to prepare magnetic particles at or below the size of iron particles, and the manufacturing cost is high because the micro-iron powder is expensive.

In addition, there has been a problem of increased manufacturing costs due to the use of rare earth oxides and metallic boron.

The foregoing explained as the background is intended merely to aid in the understanding of the background of the present disclosure, and is not intended to mean that the present disclosure falls within the purview of the related art that is already known to those having ordinary skill in the art.

### SUMMARY OF THE DISCLOSURE

Accordingly, the present applicant has researched a method to prepare Nd2Fe14B magnets with a small average particle size by synthesizing only oxides and reducing agents without additional physical processes and materials while utilizing Nd—Pr complex oxides, which are extractable from waste permanent magnets.

Accordingly, the present disclosure has been made keeping in mind the above problems occurring in the related art.

According to one aspect, a method is provided of preparing a magnetic powder, which utilizes neodymium praseodymium (Nd, Pr) mixed oxide extracted from a waste permanent magnet to obtain a magnetic powder with a small average size. Another aspect of the present disclosure provides a magnet powder.

Technical problems to be solved by the present disclosure are not limited to the above-mentioned technical problems. Other technical problems, which are not mentioned above, may be more clearly understood from the following description by those having ordinary skill in the art to which the present disclosure pertains.

A method of preparing a magnet powder according to an embodiment of the present disclosure is a method of preparing a Nd—Fe—B based magnetic powder. The method includes preparing (Nd, Pr) mixed oxide containing neodymium (Nd) and praseodymium (Pr) in a first precursor preparation step, preparing iron oxide (Fe₃O₂) in a second precursor preparation step, and preparing boron oxide (B₂O₃) in a third precursor preparation step. The method also includes mixing the prepared (Nd, Pr) mixed oxide, Fe₃O₂, and B₂O₂ to prepare a first mixture in a first mixing step and mixing the first mixture with calcium (Ca) to prepare a second mixture in a second mixing step. The method further includes inducing diffusion while shaping and pressing the second mixture in a shaping step. The method also includes reducing the shaped and pressed second mixture to prepare a magnetic substance containing Nd, iron (Fe), and boron (B) in a calcium reduction step, powdering the reduced magnetic substance in a powdering step, and removing reduction by-products from the powdered magnetic substance in a by-product removal step.

The (Nd, Pr) mixed oxide prepared in the first precursor preparation step is a (Nd, Pr) mixed oxide extracted from a waste permanent magnet and the Fe₂O₃ prepared in the second precursor preparation step is Fe₂O₃ prepared through a water spray process.

In the first mixing step, the (Nd, Pr) mixed oxide, Fe₂O₃, and B₂O₃ are mixed in a molar ratio of 5-7:13-15:2-5.

The method further includes calcinating the first mixture in a calcination step after the first mixing step.

The calcination step is carried out in an air atmosphere at a temperature in a range of 780 to 820° C. for 2 to 4 hours.

A rate of increasing the temperature in the calcination step is in a range of 4 to 6° C./min.

The method further includes, after the calcination step, reducing the calcinated first mixture with hydrogen in a hydrogen reduction step.

The hydrogen reduction step is carried out in a hydrogen atmosphere at a temperature in a range of 600 to 650° C. for 1 to 3 hours.

A rate of increasing the temperature in the hydrogen reduction step is in a range of 4 to 6° C./min.

In the second mixing step, the first mixture and calcium are mixed in a mass ratio of 3:1 to 1:2 to prepare the second mixture.

In the pressing step, the second mixture is shaped by pressing at a pressure in a range of 10 to 25 megapascal (MPa).

The calcium reduction step is carried out in an inert atmosphere at a temperature in a range of 750 to 900° C. for 2 to 4 hours.

A rate of increasing the temperature in the calcium reduction step is in a range of 4 to 6° C./min.

In the by-product removal step, the powdered magnetic substance is dispersed in a cleaning solution of a mixture of ammonium salts and methanol to remove the reducing by-products.

After the by-product removal step, the method further includes obtaining the magnetic powder remaining in the cleaning solution and then drying the magnetic powder in a drying step.

A magnetic powder according to an embodiment of the present disclosure is prepared by the above-described embodiments of a method of preparing a magnetic powder.

The magnet powder is (Nd, Pr)₂Fe₁₄B and has an average particle size of 1 μm or less.

According to an embodiment of the present disclosure, by utilizing (Nd, Pr) composite oxide extracted from rare earth permanent magnets of discarded electric vehicle drive motors, and by utilizing B₂O₃ rather than Fe₂O₃ and metallic B prepared by a water spray process, it is possible to obtain NdFeB-based permanent magnets without adding additional crushing processes or chemical substances, but solely by using oxides and Ca, which is a reducing agent.

In addition, by utilizing (Nd, Pr) mixed oxides with an average particle size of 2 to 3 μm, it is possible to obtain NdFeB-based permanent magnets with an average particle size of 1 μm or less.

### BRIEF DESCRIPTION OF THE DRAWINGS

FIG. 1 is a flowchart illustrating a method of preparing a magnetic powder according to an embodiment of the present disclosure.

FIG. 2 is a flowchart illustrating a method of preparing a magnetic powder according to another embodiment of the present disclosure.

FIG. 3 is a flowchart illustrating a method of preparing a magnetic powder according to still another embodiment of the present disclosure.

FIG. 4 is a scanning electron microscope (SEM) photograph illustrating a magnetic powder prepared by a method of preparing magnetic powder according to an embodiment of the present disclosure.

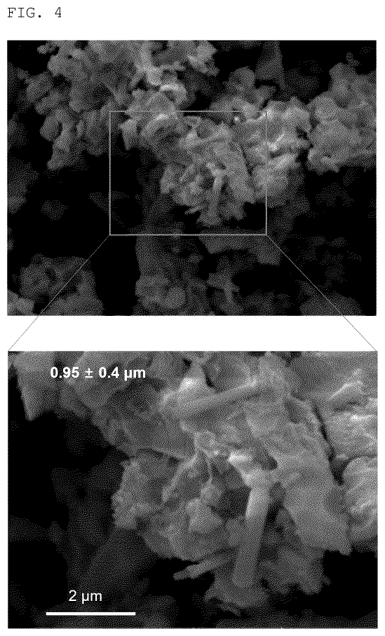

FIG. 5A is a SEM photograph and an X-ray diffraction analysis result illustrating neodymium praseodymium (Nd, Pr) mixed oxide used in a method of preparing magnetic powder according to an embodiment of the present disclosure.

FIG. 5B is a SEM photograph and an X-ray diffraction analysis result illustrating iron oxide used in a method of preparing magnetic powder according to an embodiment of the present disclosure.

FIG. 5C is a SEM photograph and an X-ray diffraction analysis result illustrating boron oxide used in a method of preparing magnetic powder according to an embodiment of the present disclosure.

FIG. 6A is a SEM photograph and an X-ray diffraction analysis result of a particle after a calcination step in a method of preparing magnetic powder according to an embodiment of the present disclosure.

FIG. 6B is a SEM photograph and an X-ray diffraction analysis result of a particle after a hydrogen reduction step in a method of preparing magnetic powder according to an embodiment of the present disclosure.

FIG. 6C is a SEM photograph and an X-ray diffraction analysis result of a particle after a calcium reduction step in a method of preparing magnetic powder according to an embodiment of the present disclosure.

FIG. 7A is a SEM photograph illustrating a magnetic powder prepared according to Example 1.

FIG. 7B is a SEM photograph illustrating a magnetic powder prepared according to Example 2.

FIG. 7C is a SEM photograph illustrating a magnetic powder prepared according to Example 3.

FIG. 8 is a graph illustrating magnetic properties of a magnetic powder prepared according to Examples 1-3.

FIG. 9 is a graph illustrating magnetic properties of a magnet powder before and after a by-product removal step of Example 1.

### DETAILED DESCRIPTION OF THE DISCLOSURE

Hereinafter, embodiments disclosed in the present specification are described in detail with reference to the accompanying drawings. The same or similar constituent elements are assigned with the same reference numerals throughout the description and drawings, and the repetitive description thereof has been omitted.

The suffixes ‘module’, ‘unit’, ‘part’, and ‘portion’ used to describe constituent elements in the following description are used together or interchangeably in order to facilitate the description, but the suffixes themselves do not have distinguishable meanings or functions.

In the description of the embodiments disclosed in the present specification, the specific descriptions of publicly known related technologies have been omitted where it has been determined that the specific descriptions may obscure the subject matter of the embodiments disclosed in the present specification. In addition, it should be interpreted that the accompanying drawings are provided only to allow those having ordinary skill in the art to better understand the embodiments disclosed in the present specification. The technical spirit disclosed in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

Singular expressions include plural expressions unless clearly described as different meanings in the context.

In the present specification, it should be understood that the terms “comprises,” “comprising,” “includes,” “including,” “containing,” “has,” “having” or other variations thereof are inclusive. Therefore, the terms specify the presence of stated features, integers, steps, operations, elements, components, or combinations thereof, but do not preclude the presence or addition of one or more other features, integers, steps, operations, elements, components, or combinations thereof.

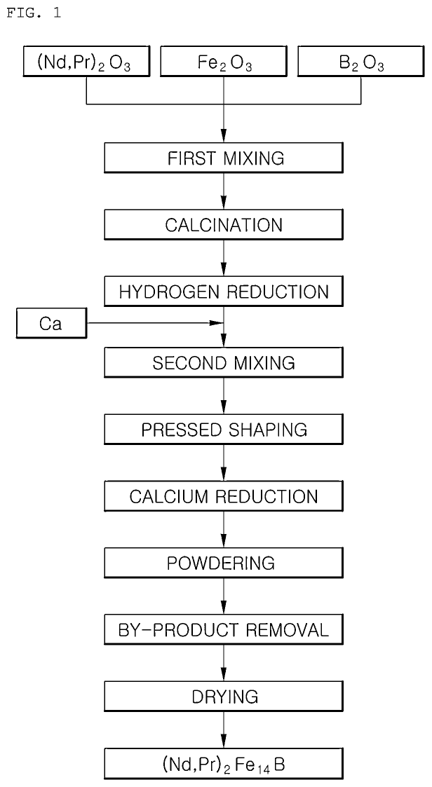

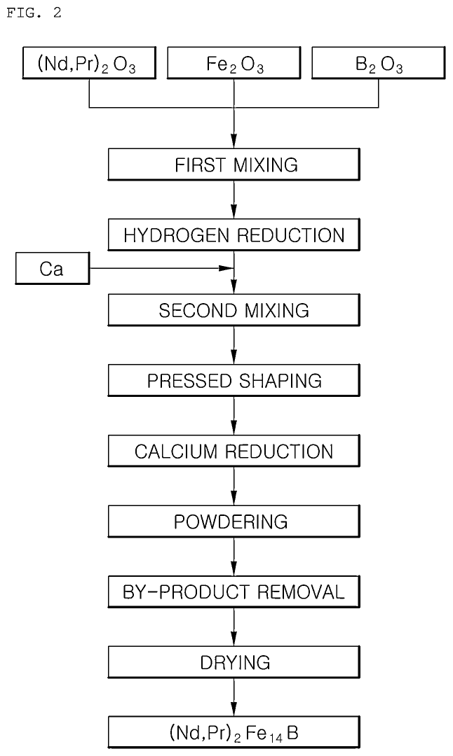

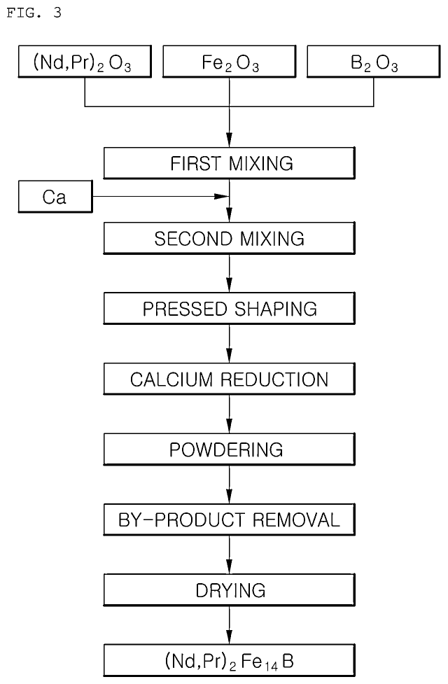

FIG. 1 is a flowchart illustrating a method of preparing the magnetic powder according to an embodiment of the present disclosure. FIG. 2 is a flowchart illustrating a method of preparing a magnetic powder according to another embodiment of the present disclosure. FIG. 3 is a flowchart illustrating a method of preparing a magnetic powder according to still another embodiment of the present disclosure.

First, as illustrated in FIG. 1, a method of preparing a magnetic powder according to an embodiment of the present disclosure is a method of preparing an Nd—Fe—B-based magnetic powder, in which neodymium praseodymium (Nd, Pr) mixed oxide, iron oxide (Fe₃O₂), and boron oxide (B₃O₂), which are materials for the Nd—Fe—B-based magnetic powder, are prepared.

For example, a first precursor preparation step is a step of preparing (Nd, Pr) mixed oxide containing neodymium (Nd) and praseodymium (Pr). In this step, Nd is extracted from waste permanent magnets, but a recycling process is performed to a (Nd, Pr) mixed oxide state rather than to a metallic Nd state, which may significantly shorten the Nd extraction process.

In this case, the (Nd, Pr) mixed oxide is extracted in the form of (Nd, Pr)₂O₃.

Therefore, the (Nd, Pr) mixed oxide contains Nd: 60 to 65 wt %, Pr: 35 to 38 wt %, and other impurities.

For example, (Nd, Pr) mixed oxide contains each element in the content shown in Table 1 below.

TABLE 1

| Element | Content (wt %) |
|---|---|
| Al | 0.0326 |
| Si | 0.1149 |
| P | 0.6599 |
| Ca | 0.2822 |
| Pd | 0.0324 |
| Cl | 0.1213 |
| Ni | 0.0192 |
| Pr | 36.0104 |
| Nd | 62.7271 |

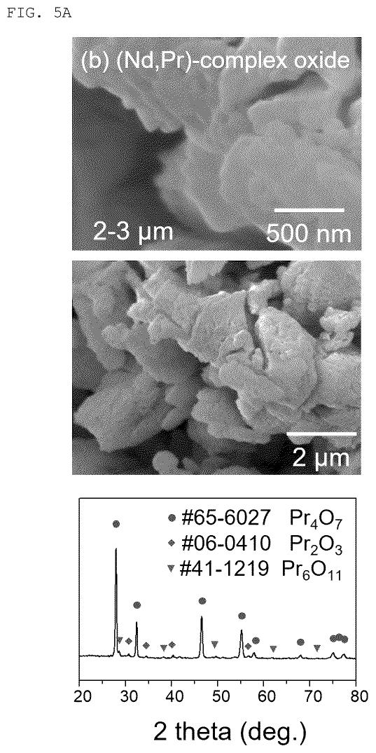

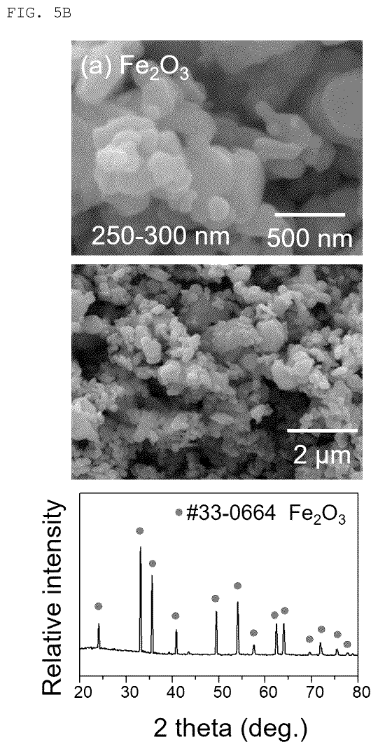

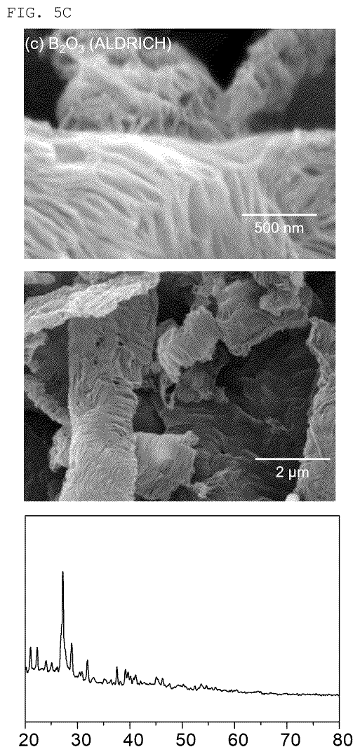

Further, as illustrated in FIG. 5A, the (Nd, Pr) mixed oxide has a particle size of 2 to 3 μm.

Meanwhile, a second precursor preparation step is a step of preparing iron oxide in which Fe₂O₃ prepared by a water spray process is used.

In this case, the iron oxide has a particle size of 250 to 300 μm, as illustrated in FIG. 5B.

Further, a third precursor preparation step is a step of preparing boron oxide in which B₃₀₂ is used rather than metallic boron for boron.

When the (Nd, Pr) mixed oxide, the iron oxide, and the boron oxide are prepared, the prepared (Nd, Pr) mixed oxide, iron oxide, and boron oxide are mixed.

A first mixing step is a step of mixing the prepared (Nd, Pr) mixed oxide, iron oxide, and boron oxide to prepare a first mixture in which the (Nd, Pr) mixed oxide, iron oxide, and boron oxide are mixed in a molar ratio according to stoichiometry.

Therefore, the (Nd, Pr) mixed oxide, the iron oxide and the boron oxide are mixed in a molar ratio of 5 to 7:13 to 15:2 to 5. For example, the (Nd, Pr) mixed oxide, the iron oxide, and the boron oxide are mixed uniformly using an acoustic mixer in a molar ratio of 6.2:14:4.3.

As described above, when the first mixture is prepared, a calcination treatment is performed to diffuse the elements in the first mixture and to remove unnecessary elements contained in the first mixture.

A calcination step is a step in which the first mixture is calcinated by heat treatment, which in one embodiment may be at a temperature in a range of 780 to 820° C., for 2 to 4 hours in an air atmosphere.

In this case, it may be desirable to maintain a rate of increasing the temperature in a range of 4 to 6° C./min when increasing the temperature for the calcination treatment.

In general, the reason for performing the calcination treatment is to remove organic materials when manufacturing the magnetic powder. However, the calcination step performed in this embodiment is to pre-synthesize the (Nd, Pr) mixed oxide, the iron oxide, and the boron oxide in a mixed state with each other before proceeding with a hydrogen reduction and a calcium reduction. It is advantageous to reduce the particle size of the magnetic powder that is finally produced when the first mixture becomes a composite state through the calcination treatment.

Meanwhile, the synthesis of Nd oxide into neodymium iron oxide (NdFeO₃) requires a minimum heat treatment temperature of 750° C. However, in this embodiment, a lower limit value of the heat treatment temperature in the calcination step is set to 780° C. for stability of heat transfer. Further, an upper limit value of the heat treatment temperature in the calcination step is set to 820° C., because too high treatment temperature in the calcination step may cause the particle size of the magnetic powder to increase.

In addition, in order to keep the particle size of the magnetic powder small, it may be desirable that the heat treatment time in the calcination step is set to 2 to 4 hours, and the rate of increasing the temperature is maintained at 4 to 6° C./min.

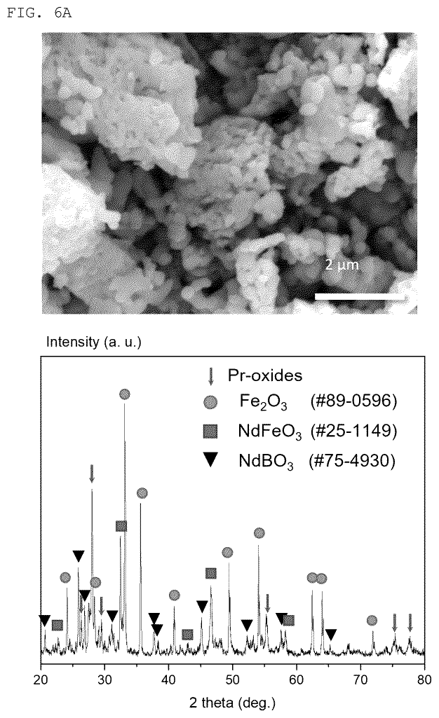

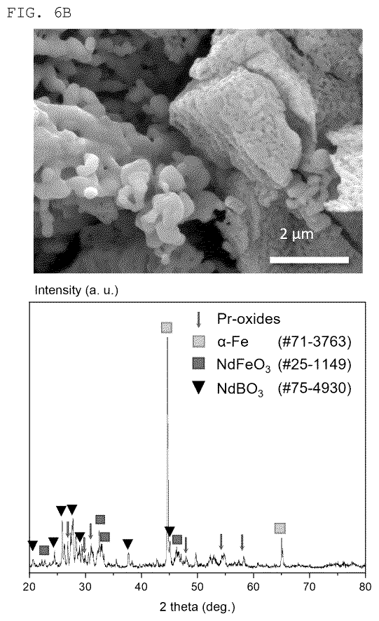

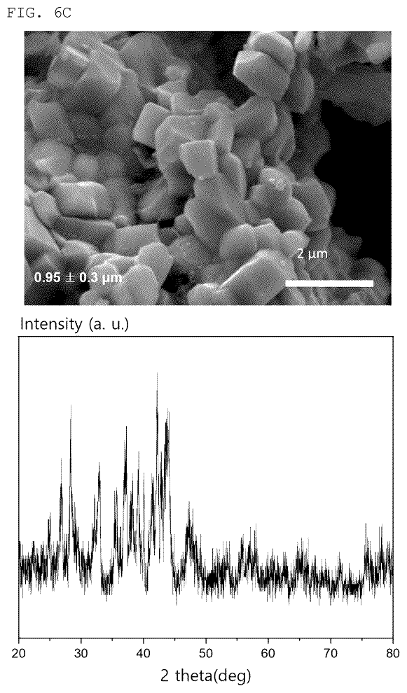

When this calcination treatment is performed, as illustrated in FIG. 6A, some unnecessary impurities are removed while Nd, Pr, iron (Fe), and boron (B) are rearranged, and compounds may be created with each other.

Then, after the calcination treatment, the calcination-treated first mixture is reduced using hydrogen.

A hydrogen reduction step is a step in which the calcinated first mixture is reduced with hydrogen, which may be in a hydrogen atmosphere at a temperature in a range of 600 to 650° C., for 1 to 3 hours.

In this case, it may be desirable to maintain a rate of ° C./min when increasing increasing temperature of 4 to 6° C./min when increasing temperature for the hydrogen reduction step.

In addition, when lowering the temperature after the hydrogen reduction treatment, the temperature may be lowered in an inert atmosphere instead of a hydrogen atmosphere.

The reason for reducing the calcinated first mixture with hydrogen is to reduce the iron oxide in advance to obtain α-Fe. In addition, the amount of calcium (Ca) used as a reducing agent is reduced to reduce calcium by-products. Also, excessive heat generated during reduction diffusion is prevented to ensure that a subsequent calcium reduction step proceeds smoothly.

In addition, Fe and mixed oxides with small particle size may be obtained by the calcination and hydrogen reduction steps. The Fe and mixed oxides with small particle size also have an effect on the particle size of the final magnetic powder. The particle size of the final magnetic powder becomes smaller as the particles interfere with each other through the multiple steps of heat treatment, especially as other mixed oxides interfere with the growth of Fe.

Therefore, it may be desirable that the temperature and time in the hydrogen reduction step be 600 to 650° C. and 1 to 3 hours for stable heat transfer based on 600° C., which is a temperature at which the iron oxide may change into Fe.

When this hydrogen reduction treatment has been performed, Pr oxide is considerably removed and most of the Fe₂O₃ is converted to α-Fe of the BCC structure, as illustrated in FIG. 6B.

Then, after the hydrogen reduction treatment has been performed, calcium (Ca) is added to the hydrogen reduced first mixture.

A second mixing step is a step of preparing a second mixture by mixing calcium (Ca), which is a reducing agent, into the hydrogen reduced first mixture. It may be desirable that the first mixture and calcium (Ca) are mixed in a mass ratio of 3:1 to 1:2 to prepare the second mixture. For example, the first mixture and calcium (Ca) are mixed uniformly in a mass ratio of 0.32:0.3.

As described above, when the second mixture has been prepared, the second mixture is pressed and shaped.

A shaping step is a step in which the second mixture is pressed and shaped to induce the diffusion of each element. The second mixture is charged into a circular mold and then pressed and shaped.

In this case, the second mixture may be shaped while being pressed at a pressure in a range of 10 to 25 megapascal (MPa).

In case of preparing the magnetic powder by applying the calcium reduction and diffusion method of the related art, it may be necessary to press and shape the mixture at a high pressure of 35 MPa or more in the shaping step. However, in this embodiment, since Nd, Fe, and B are mixed and shaped in the oxide state, a pressure of 10 to 25 MPa, which is relatively low compared to the related art, is sufficient to allow the elements to diffuse and react with each other.

When this pressed-shaping has been completed, the pressed-shaped second mixture is reduced using a reducing agent contained in the second mixture.

A calcium reduction step is a step in which a magnetic substance containing Nd, Fe, and B is prepared by reducing using calcium (Ca), which is a reducing agent contained in the pressed-shaping second mixture, and it may be desirable to perform the calcium reduction step in an inert atmosphere at 750 to 900° C., for 2 to 4 hours.

In this case, it may be desirable to maintain a rate of increasing temperature of 4 to 6° C./min when increasing temperature for the calcium reduction step.

The calcium reduction step is an essential step to obtain the final magnetic powder, which is a Nd—Fe—B based particle. Calcium (Ca) is a reducing agent that is capable of reducing Nd and Pr, rare earth atoms with very high reduction energy, and metal oxides are reduced using calcium (Ca) and alloyed by diffusion.

Therefore, the calcium reduction step may be performed at 750 to 900° C. and 2 to 4 hours for stable heat transfer based on 692° C., which is a minimum temperature at which (Nd, Pr)₂Fe₁₄B is formed by the calcium reduction reaction.

This calcium reduction treatment allows Nd, Fe, and B to diffuse and synthesize with each other to produce an NdFeB-based magnetic substance, as illustrated in FIG. 6C.

When the NdFeB-based magnetic substance has been prepared, the NdFeB-based magnetic substance is powdered to the desired size.

A powdering step is a step of powdering the NdFeB-based magnetic substance to the desired size. In this case, various methods may be applied to powder the NdFeb-based magnetic substance.

Meanwhile, when the powdering of the NdFeb-based magnetic substance has been completed, reduction by-products are removed from the powdered magnetic substance.

A by-product removal step is a step of removing reduction by-products from the powdered magnetic substance. The powdered magnetic substance is dispersed in a cleaning solution in which ammonium salt (NH₄NO₃) and methanol are mixed, thereby removing the reduction by-products.

In order to prevent contamination of the powdered magnetic substance, i.e., the magnetic powder, the calcium dispersants are removed using the cleaning solution in a schlenk line in the by-product removal step.

Further, after the by-product removal step, it may be desirable that a drying step is further performed to obtain the magnetic powder remaining in the cleaning solution and then dry the magnetic powder.

The magnetic powder obtained as described above is Nd₂Fe₁₄B, and the particle size of the magnetic powder is kept at or below 1 μm on average.

Further, the magnetic powder maintains a saturation magnetization value M of 35.88 electromagnetic unit per gram (emu/g) and a coercive force Hc of 6506.7 Oersted (Oe).

Meanwhile, the present disclosure provides a method for preparing a magnetic powder that may reduce the number of processes than the embodiment described above.

For example, as illustrated in FIG. 2, the calcination step performed in the above-described embodiment may be omitted.

In addition, the hydrogen reduction step may be omitted in addition to the calcination step performed in the above-described embodiments, as illustrated in FIG. 3.

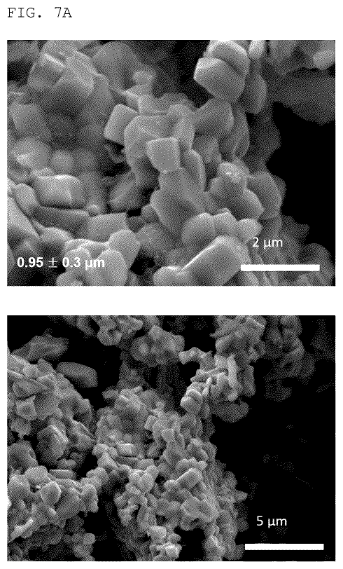

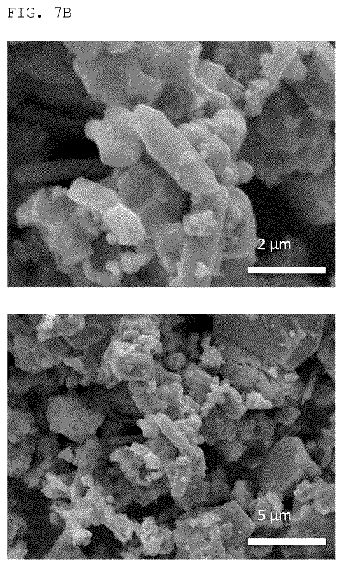

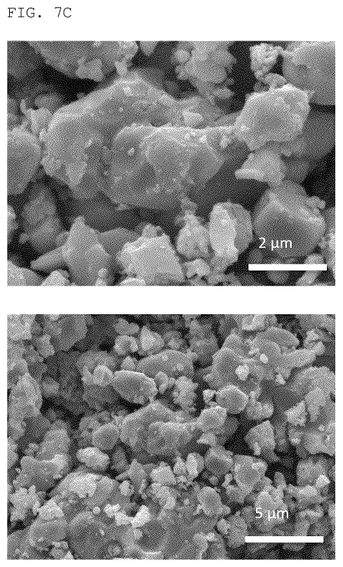

Hereinafter, in order to compare the states of the magnetic powders prepared according to the various embodiments, SEM images were analyzed for the magnetic powder prepared according to FIG. 1 (Example 1), the magnetic powder prepared according to FIG. 2 (Example 2), and the magnetic powder prepared according to FIG. 3 (Example 3), and are illustrated in FIGS. 7A-7C, respectively. In this case, FIG. 7A is a SEM image of the magnetic powder according to Example 1, FIG. 7B is a SEM image of the magnetic powder according to Example 2, and FIG. 7C is a SEM image of the magnetic powder according to Example 3.

As illustrated in FIG. 7A-FIG. 7C, it could be confirmed that the magnetic powder prepared according to Examples 1-3 had an average particle size in the range of 1 to 2 μm. However, it could be confirmed that the particle size of the magnetic powder varied depending on whether the calcination and hydrogen reduction steps were performed.

In more detail, it could be confirmed that the average particle size was kept at or below 1 μm in case of the Example 1, which performed both the calcination and hydrogen reduction steps, and the particle size was the smallest among the three Examples. It was also confirmed that the particle size of the Example 2, which performed the hydrogen reduction step, was larger than the particle size of the Example 1, but smaller than the particle size of the Example 3, which did not undergo the hydrogen reduction step.

In addition, it could be confirmed that the amount of impurities contained in the magnetic powder varied depending on whether the calcination and hydrogen reduction steps were performed.

In more detail, it could be confirmed that the amount of impurities was smallest in case of the Example 1 that performed both the calcination and hydrogen reduction steps. It could also be confirmed that the Example 2, in which the hydrogen reduction step was performed, had more impurities than the Example 1, but less impurities than the Example 3, which did not undergo the hydrogen reduction step.

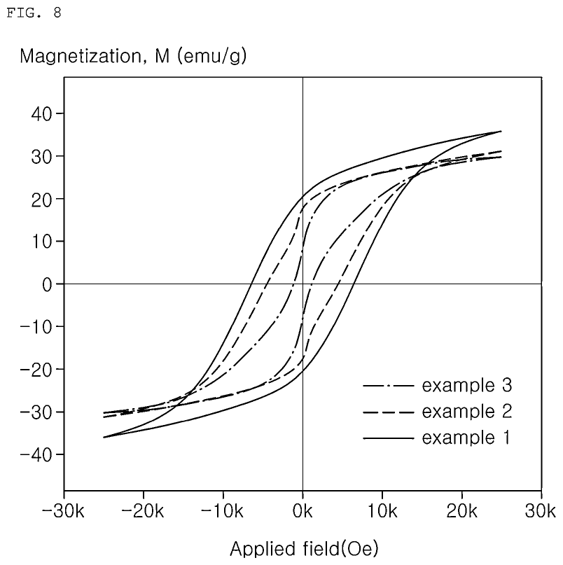

Next, the magnetic properties of the magnetic powders were measured for the Examples 1-3, and the results are shown in Table 2 and FIG. 8.

FIG. 8 is a graph illustrating magnetic properties of the magnetic powder prepared according to Examples 1-3.

TABLE 2

| Classification | Mₛ (emu/g) | Mᵣ (emu/g) | H_{ci} (Oe) |
|---|---|---|---|
| Example 1 | 35.884 | 20.674 | 6506.7 |
| Example 2 | 31.127 | 17.328 | 4425.6 |
| Example 3 | 29.954 | 9.0076 | 1176.3 |

As can be seen in Table 2 and FIG. 8, in the results of magnetic properties for Examples 1-3, it is not meaningful to compare the saturation magnetization (Ms) since the by-product removal step has not yet been performed. However, it could be confirmed that the Example 1 is significantly higher than the Example 2 and the Example 3 when comparing the coercive force (Hci).

Therefore, the small and uniform particle size also has an effect on the high magnetic properties.

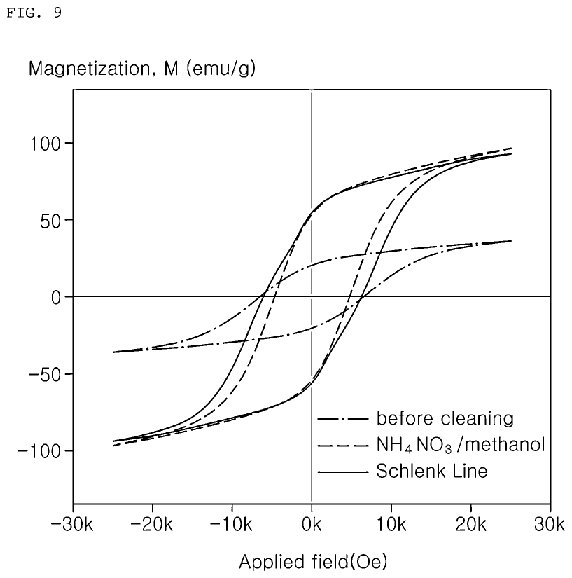

Further, the magnetic properties of the magnetic powder were measured before and after the by-product removal step for Example 1, and the results are shown in Table 3 and FIG. 9.

The by-product removal step was performed such that the cleaning was performed 3 to 5 times for 20 minutes after 0.05 M to 0.4 M NH₄NO₃/Methanol was set as the cleaning solution. In the last step, the residual by-products calcium nitrate (Ca(NO₃)₂) are removed with the same amount of pure methanol, and finally, the cleaning is completed by vacuum drying (65 to 90° C.) in a vacuum oven to obtain (Nd, Pr) FeB powder particles.

Then, in a schlenk line in Table 3, 5 to 60 g of zeolite and calcium-reduced powder are added to 200 mL of the cleaning solution, and high-purity inert gas argon or molecular nitrogen (Ar or N₂) is injected three to five times for 20 minutes. The zeolite and the cleaning solution should be changed repeatedly when the process is repeatedly performed three to five times. In the last step, the residual by-products Ca(NO₃)₂ are removed with the same amount of pure methanol, and finally, the cleaning is completed by vacuum drying (65 to 90° C.) in a vacuum oven to obtain (Nd, Pr) FeB powder particles.

FIG. 9 is a graph illustrating magnetic properties of the magnetic powder before and after a by-product removal step of Example 1.

TABLE 3

| Classification | | | |
|---|---|---|---|
| (Example 1) | Mₛ (emu/g) | Mᵣ (emu/g) | H_{ci} (Oe) |
| Before by- | 35.884 | 20.674 | 6506.7 |
| product removal | | | |
| step | | | |
| After by- | 96.422 | 54.741 | 4724.3 |
| product removal | | | |
| step | | | |
| Schlenk line | 93.548 | 55.917 | 6175 |

As can be seen in Table 3 and FIG. 9, it may be seen that the overall magnetic properties increase after the removal of calcium by-products. In particular, it could be confirmed that the saturation magnetization (Ms) increased due to the removal of calcium by-products. Further, the coercive force (Hci) did not degrade significantly compared to before the by-product removal step.

While the present disclosure has been described with reference to the accompanying drawings and the aforementioned embodiments, the present disclosure is not limited thereto but defined by the appended claims. Therefore, those having ordinary skill in the art can variously change and modify the present disclosure without departing from the technical spirit of the appended claims.

What is claimed is:

1. A method of preparing a Nd—Fe—B based magnetic powder comprising:
preparing (Nd, Pr) mixed oxide containing neodymium (Nd) and praseodymium (Pr) in a first precursor preparation step;
preparing iron oxide (Fe₂O₃) in a second precursor preparation step;
preparing boron oxide (B₂O₃) in a third precursor preparation step;
mixing the prepared (Nd, Pr) mixed oxide, the Fe₂O₃, and the B₂O₃ to prepare a first mixture in a first mixing step;
mixing the first mixture with calcium (Ca) to prepare a second mixture in a second mixing step;
inducing diffusion while shaping and pressing the second mixture in a shaping step;
reducing the shaped and pressed second mixture to prepare a reduced magnetic substance containing Nd, iron (Fe), and boron (B) in a calcium reduction step;
powdering the reduced magnetic substance to prepare a powdered magnetic substance in a powdering step; and
removing reduction by-products from the powdered magnetic substance in a by-product removal step.

2. The method of claim 1, wherein the (Nd, Pr) mixed oxide prepared in the first precursor preparation step is extracted from a waste permanent magnet, and wherein the Fe₂O₃ prepared in the second precursor preparation step is prepared through a water spray process.

3. The method of claim 1, wherein, in the first mixing step, the (Nd, Pr) mixed oxide, Fe₃O₂, and B₃₀₂ are mixed in a molar ratio of 5-7:13-15:2-5.

4. The method of claim 1, further comprising:
calcinating the first mixture in a calcination step after the first mixing step.

5. The method of claim 4, wherein the calcination step is carried out in an air atmosphere at a temperature in a range of 780 to 820° C. for 2 to 4 hours.

6. The method of claim 5, wherein a rate of increasing the temperature in the calcination step is in a range of 4 to 6° C./min.

7. The method of claim 4, further comprising:
reducing the calcinated first mixture with hydrogen in a hydrogen reduction step after the calcination step.

8. The method of claim 7, wherein the hydrogen reduction step is carried out in a hydrogen atmosphere at a temperature in a range of 600 to 650° C. for 1 to 3 hours.

9. The method of claim 8, wherein, in the hydrogen reduction step, the rate of increasing the temperature is in a range of 4 to 6° C./min.

10. The method of claim 1, wherein, in the second mixing step, the first mixture and calcium are mixed in a mass ratio of 3:1 to 1:2 to prepare the second mixture.

11. The method of claim 1, wherein, in the shaping step, the second mixture is shaped by pressing at a pressure in a range of 10 to 25 megapascal (MPa).

12. The method of claim 1, wherein the calcium reduction step is carried out in an inert atmosphere at a temperature in a range of 750 to 900° C. for 2 to 4 hours.

13. The method of claim 12, wherein in the calcium reduction step, the rate of increasing the temperature is in a range of 4 to 6° C./min.

14. The method of claim 1, wherein, in the by-product removal step, the powdered magnetic substance is dispersed in a cleaning solution of a mixture of ammonium salt and methanol to remove the reducing by-products.

15. The method of claim 14, further comprising:
obtaining the magnetic powder remaining in the cleaning solution; and
then drying the magnetic powder in a drying step after the by-product removal step.

16. A magnetic powder prepared by the method of claim 1.

17. The magnet powder of claim 16, wherein the magnetic powder is (Nd, Pr)₂Fe₁₄B.

18. The magnetic powder of claim 16, wherein the magnetic powder has an average particle size of 1 μm or less.
